(19) United States
(12) Patent Application Publication
(10) Pub. No.: US 2024/0171719 A1
(43) Pub. Date: May 23, 2024

(54) Rendering an Immersive Experience

(71) Applicant: KAGENOVA LIMITED, Guildford (GB)

(72) Inventors: Martin ENDER, Guildford (GB); Paulo J.R. DE MELLO, Guildford (GB); Jason MCEWEN, Guildford (GB)

(21) Appl. No.: 18/279,751

(22) PCT Filed: Mar. 1, 2022
(86) PCT No.: PCT/EP2022/055144

§ 371 Date: Sep. 1, 2023

(30) Foreign Application Priority Data
Mar. 1, 2021 (GB) 2102861.8

(51) Int. Cl. H04N 13/117; G06T 15/04

(52) U.S. Cl. CPC H04N 13/117; G06T 15/04; G06T 2210/44

(57) ABSTRACT

An immersive experience is rendered. The immersive experience comprises source and destination nodes. The source node comprises a source scene and a source geometry. The destination node comprises a destination scene and a destination geometry. A first representation of the source scene is rendered. The first representation of the source scene represents the source scene at a first viewpoint in the source geometry. A second, different representation of the source scene is rendered. The second representation of the source scene represents the source scene at a second, different viewpoint in the source geometry. A transition is rendered from the source scene to the destination scene. The transition comprises a third, different representation of the source scene and a first representation of the destination scene. The third representation of the source scene represents the source scene at a third, different viewpoint in the source geometry.

### FIELD

The present disclosure relates to rendering an immersive experience.

### BACKGROUND

A virtual tour is a type of immersive experience. Existing virtual tours can allow a user to get an impression of a location of interest, for example from the comfort of their own home. Examples of such locations include, but are not limited to, museums, tourist destinations, and real estate properties.

Existing virtual tours are generally experienced through an internet browser. The user uses a mouse to look around a 360° image and then clicks on other locations to jump to a different viewpoint. Consumer-grade virtual reality (VR) hardware is now widely available. Such hardware can, in principle, provide a user with a much more immersive experience of a virtual tour than is possible using an internet browser. However, many existing tours and tour systems do not provide a sufficiently good immersive experience.

For example, existing tour systems generally lack 6-degrees-of-freedom (6DOF) motion. Virtual tours built from 360° images can sometimes only be viewed with three degrees-of-freedom (3DOF) motion. As such, they are only viewed by the user rotating their head. However, immersive tours with 6DOF motion enable both rotation and translation. This allows the user to move around to explore the space.

When exploring a virtual tour using a VR headset, the user would expect to be able to physically walk around the space they are exploring in order to move from one viewpoint to another. This is not the case with existing tour systems, which usually ‘teleport’ the user to a new viewpoint, or forcibly move them between viewpoints with a precomputed motion that does not correspond to the user's movement. Recent omnidirectional treadmills promise to allow the user to physically walk around a limitless “play area”. However, this exacerbates the problem as existing virtual tours are not equipped to support this kind of movement.

### SUMMARY

According to a first aspect there is provided a method of rendering an immersive experience, the immersive experience comprising a source node and a destination node, the source node comprising a source scene and a source geometry, the destination node comprising a destination scene and a destination geometry, the method comprising:
rendering a first representation of the source scene, the first representation of the source scene representing the source scene at a first viewpoint in the source geometry;
rendering a second, different representation of the source scene, the second representation of the source scene representing the source scene at a second, different viewpoint in the source geometry; and
rendering a transition from the source scene to the destination scene, the transition comprising:
   a third, different representation of the source scene, the third representation of the source scene representing the source scene at a third, different viewpoint in the source geometry; and
   a first representation of the destination scene.

According to a second aspect there is provided apparatus configured to perform a method according to the first aspect.

According to a third aspect, there is provided a computer program comprising instructions which, when the program is executed by a computer, cause the computer to perform a method according to the first aspect.

### BRIEF DESCRIPTION OF THE DRAWINGS

For a better understanding of the present disclosure and to show how the same may be carried into effect, there will now be described by way of example only, specific embodiments, methods and processes according to the present disclosure with reference to the accompanying drawings in which:

FIG. 1 shows a block diagram of an example of a system in which immersive experience rendering is carried out in accordance with examples;

FIG. 2 shows a block diagram of an example part of the example system shown in FIG. 1;

FIG. 3 shows a block diagram of an example of a node;

FIG. 4 shows a representation of an example of node geometries of an immersive experience;

FIG. 5 shows a representation of another example of node geometries of an immersive experience;

FIG. 6 shows a representation of another example of node geometries of an immersive experience;

FIG. 7 shows a representation of another example of node geometries of an immersive experience;

FIG. 8 shows a graph of an example set of nodes of an immersive experience;

FIG. 9 shows another graph of the example set of nodes shown in FIG. 8;

FIG. 10 shows another graph of the example set of nodes shown in FIG. 8; and

FIG. 11 shows another graph of the example set of nodes shown in FIG. 8.

### DETAILED DESCRIPTION

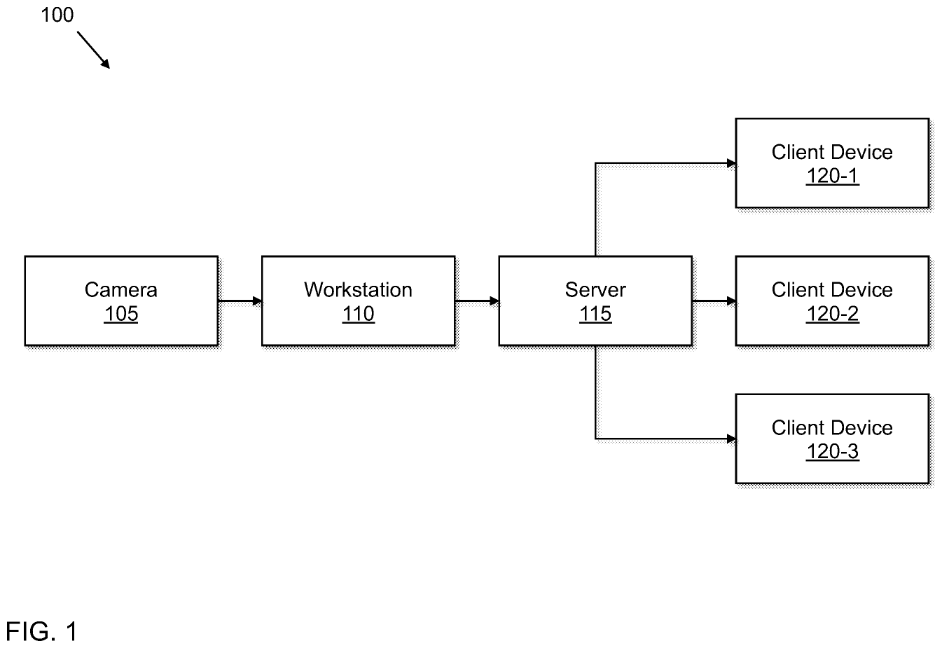

Referring to FIG. 1, there is shown an example of a system 100. Techniques described herein for rendering an immersive experience may be implemented in such an example system 100.

In this specific example, the system 100 comprises a camera 105, a workstation 110, a server 115 and three client devices 120-1, 120-2, 120-3. The system 100 may comprise different elements in other examples. In particular, the system 100 may comprise a different number of client devices 120 in other examples. The client devices 120-1, 120-2, 120-3 may take various forms. Examples include, but are not limited to, a browser running on a computing device, such as a personal computer (PC) or mobile device, a standalone VR headset, and a tethered VR headset together with a computing device.

The camera 105 is a type of scene-capture device. A scene-capture device may also be referred to as a scene-acquisition device. The camera 105 captures (also referred to herein as “acquires”) scenes.

In relation to scene acquisition, an image-based virtual tour, in accordance with examples described herein, may be captured (also referred to herein as “shot”) in various different ways.

For example, the camera 105 may comprise a dedicated 360° camera.

Alternatively, or additionally, the camera 105 may comprise a ‘regular’ camera; in other words, a camera that is not a dedicated 360° camera. Several photographs may be taken from the same location as each other to cover an entire image sphere. This may use functionality found on most current smartphones. The photographs can be stitched into a 360° image in post-production. The location at which a scene is captured may be referred to herein as a “capture viewpoint” or a “camera viewpoint”.

Unlike existing systems, examples described herein support video-based virtual tours. In examples, video-based virtual tours use separate 360° cameras. The 360° cameras record a scene from different viewpoints at the same time. For example, such 360° cameras may have back-to-back fisheye lenses. Inpainting algorithms may be used to remove each camera 105 and tripod from the recordings.

Some existing tour systems require specialised stereo or depth cameras. However, at least some examples described herein are compatible with standard 360° scenes from any camera 105 that can capture them.

In this example, the workstation 110 receives images from the camera 105. In this example, the images make up multiple 360° scenes. In this example, the workstation 110 outputs a tour. Such a tour may be referred to herein as a “fully configured” tour. The term “tour” is used herein to mean a collection of panoramic images and/or videos with a specific spatial relationship. A tour comprises a number, n, of nodes, N₁ to Nₙ. The term “panoramic” is used herein usually, but not exclusively, to refer to 360° content. However, panoramic 180° and 120° images exist and may be used in accordance with techniques described herein.

The present disclosure makes virtual tours more natural for VR or browser-based experiences. The user can move anywhere so they can freely explore the tour space. The present disclosure also generalises virtual tours to support not only static images, but 360° video content as well. This enables more types of immersive storytelling and experience.

Data used in examples described herein to define a virtual tour, its acquisition process, and related technologies will now be described.

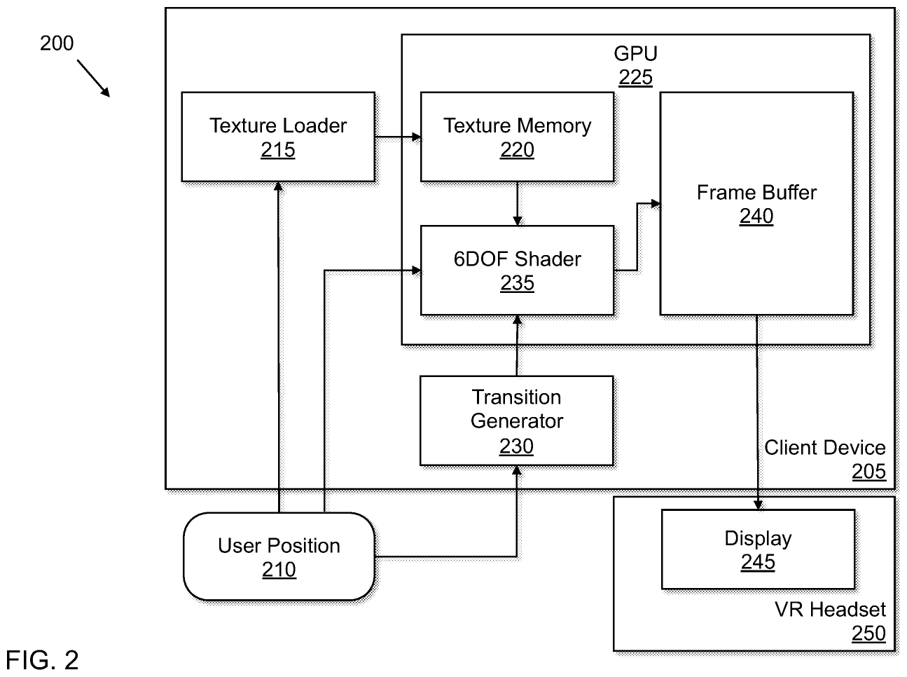

Referring to FIG. 2, there is shown an example of a subsystem 200 of the system 100 described above with reference to FIG. 1.

Although various components are depicted in FIG. 2, such components are intended to represent logical components of the example subsystem 200. Functionality of the components may be combined and/or divided. In other examples, the subsystem 200 comprises different components from those shown, by way of example only, in FIG. 2.

In this example, the subsystem 200 comprises a client device 205. The client device 205 may correspond to one of the three client devices 120-1, 120-2, 120-3 described above with reference to FIG. 1.

In this example, the client device 205 receives user position data 210. In examples described below, a transition from a source scene to a destination scene is rendered in response to movement, in a physical space, of a viewer of an immersive experience. Such movement may correspond to positional movement of the user (for example, the user walking or otherwise moving around the physical space), may include movement of the user on an omnidirectional treadmill, or otherwise. The client device 205 may determine such movement using the user position data 210.

In this example, the client device 205 comprises a texture loader 215, which receives the user position data 210. The texture loader 215 loads texture map data into texture memory 220 of a graphics processing unit (GPU) 225 of the client device 205 based on the user position data 210. The texture loader 215 can also remove texture map data from the texture memory 220.

In this example, the client device 205 comprises a transition generator 230, which receives the user position data 210. The transition generator 230 generates renderings of natural transitions.

In this example, the GPU 225 comprises a 6DOF shader 235, which receives the user position data 210. In addition, in this example, the 6DOF shader 235 is communicatively coupled to the texture memory 220 and the transition generator 230. Although the 6DOF component 235 is a 6DOF shader 235 in this example, the 6DOF component 235 may take other forms. For example, the 6DOF component 235 may not be a shader and may be outside the GPU 225. The 6DOF component 235 may, in any event, be considered to comprise separate 6DOF and transition/blending components, but such components may not be considered to be separate in other examples.

In this example, the 6DOF shader 235 outputs to a frame buffer 240 of the GPU 225.

In this example, the content of the frame buffer 240 is caused to be displayed on a display 245 of a VR headset 250 tethered to the client device 205. Examples described below involve causing first and second representations of a source scene and a transition from the source scene to the destination scene to be displayed on the display 245 of the virtual reality headset 250.

The user position data 210 described above may be received from tracking information of the VR headset 250, from user input for a browser-based experience, or in another manner.

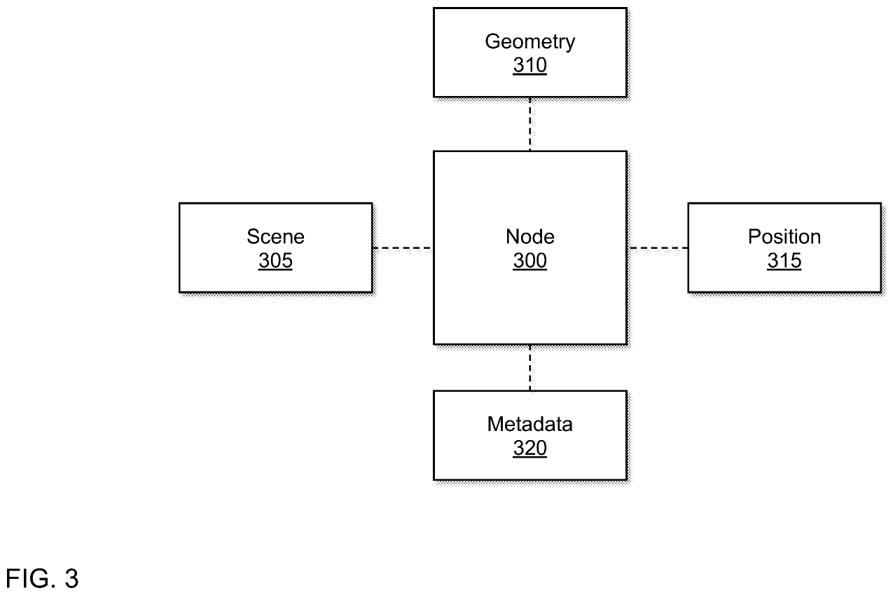

Referring to FIG. 3, there is shown an example of a node 300. As explained above, a tour comprises n nodes, N₁ to Nₙ. Various entities related to the node 300 are shown in FIG. 3. Such entities may be considered to be comprised in the node 300, associated with the node 300, or otherwise related to the node 300.

In this example, the node 300 comprises a scene 305, a geometry 310, a position 315 and metadata 320. The node 300 may comprise different entities in other examples.

In a specific example, the ith node, Nᵢ, of the tour is associated with a 360° scene 305, a node geometry 310, a two-dimensional (2D) position 315, rᵢ=(xᵢ, yᵢ), and an orientation 320, ψᵢ. The 360° image(s) or video(s) with which a node is associated are referred to herein as the “scene” of that node. The orientation, ψᵢ, indicates the counterclockwise rotation of the 360° image or video from the positive y-axis. The scene 305 may comprise panoramic image data and/or panoramic video data.

Examples described herein enable an immersive experience to be rendered. The immersive experience includes (at least) a first node and a second node. In examples described herein, the first node is a source node and the second node is a destination node. The source node includes a source scene and a source geometry. The destination node includes a destination scene and a destination geometry.

As explained above, examples described herein allow free movement of a user. In order to build virtual tours where the user can move freely, the user can move in the vicinity of any one camera viewpoint and can move from one viewpoint to another. Examples will be described below of how both of these features are enabled and how natural transitions are triggered and rendered. Existing tours lack natural transitions between images and/or lack movement in the vicinity of a node. For example, even if an existing tour has relatively natural transitions between nodes, the user is still constrained to the viewpoints.

To allow local movement, where users can move within the vicinity of each camera viewpoint, examples provide 6DOF motion in each of the tour's 360° scene geometries. Existing technology, such as described in WO-A1-2020/084312, may be adapted or modified to provide this functionality.

Firstly, a horizontal offset of the origin of the geometry is supported, which corresponds to the node's position, rᵢ. Secondly, each node of the tour has its own configuration, to represent the local environment as accurately as possible.

Techniques will now be described in relation to transitioning between viewpoints. Once the user moves too far away from one viewpoint and towards another viewpoint in the tour, a transition to the scene of the new viewpoint is provided. Examples described herein make this transition appear as natural and seamless as possible. There are several ways in which this may be achieved.

In more detail, the user can initially freely move within the geometry of a source node, Nᵢ. The user reaches a transition trigger and transitions from the source node, Nᵢ, to a destination node, Nⱼ, seeing a combination of both nodes. The destination node, Nⱼ, may not be the ultimate destination of the tour. For example, the user may return to the source node, Nᵢ, or may move on to a different node. The transition may be implemented via blending, morphing or in another manner. The user can then freely move within the geometry of the destination node, Nⱼ. As the user moves freely in the source and destination nodes, Nᵢ and Nⱼ, different 6DOF-distorted representations of the source and destination nodes, Nᵢ and Nⱼ, may be rendered, depending on the position of the user in the source and destination nodes, Nᵢ and Nⱼ.

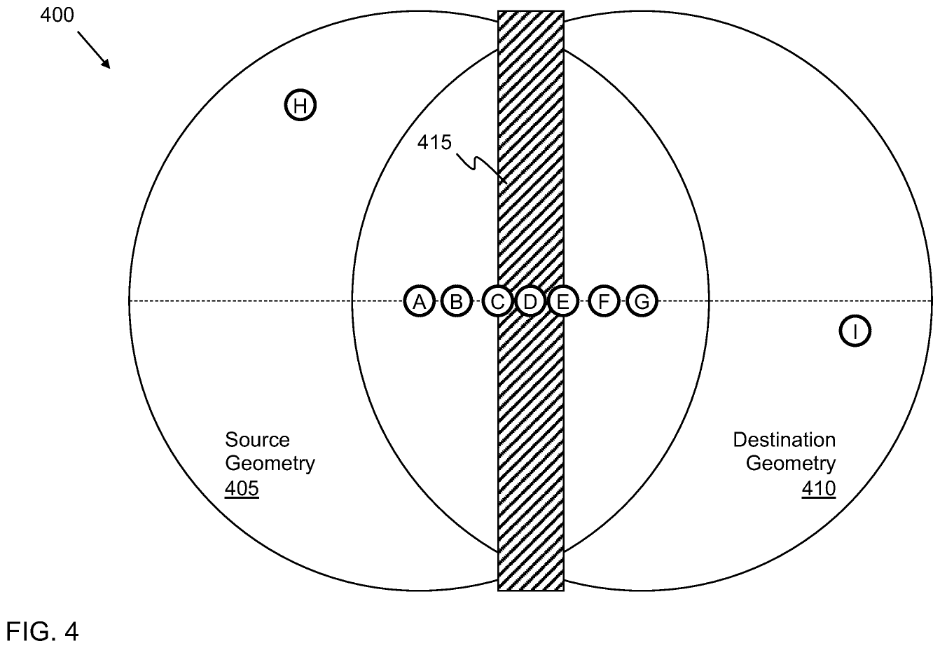

Referring to FIG. 4, there is shown an example of a collection 400 of node geometries. The node geometries include a source geometry 405 and a destination geometry 410. The source and destination geometries 405, 410 are depicted as circles in FIG. 4 for simplicity, but could have any shape. In this example, the source and destination geometries 405, 410 overlap with each other. A set of viewpoints labelled ‘A’ to ‘I’ are depicted. In this example, the user moves from viewpoint ‘A’ to viewpoint ‘G’ via viewpoints ‘B’, ‘C’, ‘D’, ‘E’, and ‘F’. In this example, the viewpoints ‘A’ through ‘G’ are in both the source and destination geometries 405, 410, viewpoint ‘H’ is in the source geometry 405 only, and viewpoint ‘I’ is in the destination geometry 410 only.

This example uses blending for the transition from the source scene to the destination scene. In this example implementation, the actual transition from the source scene to the destination scene is performed by rendering both nodes, Nᵢ and Nⱼ, with 6DOF, and alpha blending is performed between them. In this example, the blending parameter, a, smoothly changes between 0 and 1 over time. The application of 6DOF makes this transition much less jarring than merely alpha blending between static scenes of nodes, Nᵢ and Nⱼ, for example static scenes at the camera viewpoints of both nodes, Nᵢ and Nⱼ. Since 6DOF simulates how the environment would change if the user moved away from the camera's original position (the camera viewpoint), applying 6DOF while the user is somewhere between the nodes, Nᵢ and Nⱼ, brings each scene closer to the other. In this way, the blended scenes are already much more similar, and the transition between them is less noticeable and more natural to the user.

In this example, viewpoint ‘A’ corresponds to the capture viewpoint of the source scene. In this example, the representation of the source scene at viewpoint ‘A’ is not subject to 6DOF distortion.

At viewpoint ‘A’, the user does not see a contribution from the destination scene, even though viewpoint ‘A’ is in the destination geometry 410.

At viewpoint ‘B’, the user sees a 6DOF-distorted representation of the source scene. The 6DOF-distorted representation represents the source scene at viewpoint ‘B’. At viewpoint ‘B’, the user does not see a contribution from the destination scene, even though viewpoint ‘B’ is in the destination geometry 410.

At viewpoint ‘C’, the transition is triggered. At viewpoint ‘C’, 6DOF-distorted representations of both the source and destination scenes at viewpoint ‘C’ are generated. At viewpoint ‘C’ the blending parameter, a, has a value of 0. As such, the user sees a contribution from the source scene but does not see a contribution from the destination scene, even though viewpoint ‘C’ is in the destination geometry 410.

At viewpoint ‘D’, 6DOF-distorted representations of both the source and destination scenes at viewpoint ‘D’ are generated. At viewpoint ‘D’ the blending parameter, a, has a value of 0.5. As such, the user sees contributions from both the source scene and the destination scene.

At viewpoint ‘E’, 6DOF-distorted representations of both the source and destination scenes at viewpoint ‘E’ are generated. At viewpoint ‘E’ the blending parameter, a, has a value of 1. As such, the user does not see a contribution from the source scene but does see a contribution from the destination scene, even though viewpoint ‘E’ is still in the source geometry 405.

At viewpoint ‘F’, the user sees a 6DOF-distorted representation of the destination scene. The 6DOF-distorted representation represents the destination scene at viewpoint ‘F’. At viewpoint ‘F’, the user does not see a contribution from the source scene, even though viewpoint ‘F’ is still in the source geometry 405.

In this example, viewpoint ‘G’ corresponds to the capture viewpoint of the destination scene. The representation of the destination scene at viewpoint ‘G’ is not subject to 6DOF distortion. At viewpoint ‘G’, the user does not see a contribution from the source scene, even though viewpoint ‘G’ is still in the source geometry 405.

At viewpoint ‘H’, which is in the source geometry 405 but not the destination geometry 410, the user sees a 6DOF-distorted representation of the source scene and does not see a contribution from the destination scene.

At viewpoint ‘I’, which is in the destination geometry 410 but not the source geometry 405, the user sees a 6DOF-distorted representation of the destination scene and does not see a contribution from the source scene.

The shaded region 415 in FIG. 4 may therefore be considered to be a transition region.

In this example, a first representation of the source scene is rendered. The first representation of the source scene represents the source scene at a first viewpoint in the source geometry 405. The first viewpoint may, amongst others, be viewpoint ‘A’ or ‘H’.

A second, different representation of the source scene is rendered. The second representation of the source scene represents the source scene at a second, different viewpoint in the source geometry 405. The second viewpoint may, amongst others, be viewpoint ‘B’.

In this example, the second representation of the source scene is distorted with respect to the first representation of the source scene. In this example, the distortion of the second representation of the source scene with respect to the first representation of the source scene is dependent on positions of the first and second viewpoints in the source geometry 405. For example, a second representation of the source scene at viewpoint ‘B’ is distorted with respect to a first representation of the source scene at viewpoint ‘A’ or ‘H’. The distortion may correspond to 6DOF distortion.

A transition from the source scene to the destination scene is rendered. The transition comprises (i) a third, different representation of the source scene and (ii) a first representation of the destination scene. In this example, the third representation of the source scene represents the source scene at a third, different viewpoint in the source geometry 405.

The third viewpoint may, amongst others, be viewpoint ‘D’. In this example, the third viewpoint is additionally in the destination geometry 410. For example, viewpoint ‘D’ is in the destination geometry 410 in addition to being in the source geometry 405.

In this example, the first representation of the destination scene represents the destination scene at the third viewpoint. For example, the first representation of the destination scene may represent the destination scene at viewpoint ‘D’. However, as will be explained below, in other examples, the first representation of the destination scene may not represent the destination scene at the third viewpoint. This may be the case where, for example, the third viewpoint is not also in the destination geometry 410, or where the first representation of the destination scene is at a viewpoint other than the third viewpoint for any other reason. In this example, the third representation of the source scene is distorted with respect to the first and second representations of the source scene. In this example, the distortion of the third representation of the source scene with respect to the first and second representation of the source scene is dependent on positions of the first, second and third viewpoints in the source geometry 405. The distortion may, again, correspond to 6DOF distortion.

In this example, a second, different representation of the destination scene is rendered. The second representation of the destination scene represents the destination scene at a second, different viewpoint in the destination geometry 410. The second viewpoint in the destination geometry 410 may, amongst others, be viewpoint ‘F’ or ‘G’.

In this example, the first representation of the destination scene is distorted with respect to the second representation of the destination scene. In this example, the distortion of the first representation of the destination scene with respect to the second representation of the destination scene is dependent on the positions of the first and second viewpoints in the destination geometry 410. For example, where the first and second viewpoints in the destination geometry 410 are viewpoints ‘D’ and ‘F’ respectively, both the first and second representations of the destination scenes are distorted with respect to each other and with respect to a representation of the destination scene at viewpoint ‘G’ (the capture viewpoint of the destination scene). Where the first and second viewpoints in the destination geometry 410 are viewpoints ‘D’ and ‘G’ respectively, both the first and second representations of the destination scenes are distorted with respect to each other, even though the representation of the destination scene at viewpoint ‘G’ (the capture viewpoint of the destination scene) may not itself be a distorted representation of the destination scene. The distortion may, again, correspond to 6DOF distortion.

In this example, the transition comprises alpha-blending the third representation of the source scene with the first representation of the destination scene.

In this example, the transition comprises alpha-blending at least one further representation of the source scene with at least one further representation of the destination scene. In this example a first value of a blending parameter is used to alpha-blend the third representation of the source scene with the first representation of the destination scene, and at least one further, different value of the blending parameter is used to alpha-blend the at least one further representation of the source scene with the at least one further representation of the destination scene. For example, if the third viewpoint is viewpoint ‘D’, the first value of the blending parameter may be 0.5. If the at least one further representation of the source scene is alpha blended with the at least one further representation of the destination scene at a viewpoint halfway between viewpoints ‘D’ and ‘E’, the at least one further value of the blending parameter may include 0.75.

A transition from the destination scene 410 to the source scene 405 may also be rendered. This may correspond to the user returning from the destination scene 410 to the source scene 405. The transition from the destination scene 410 to the source scene 405 may be based on a fourth, different representation of the source scene. The fourth representation of the source scene is different from the first, second and third representations of the source scene. The fourth representation of the source scene represents the source scene at a fourth, different viewpoint in the source geometry 405. The fourth viewpoint in the source geometry 405 is different from the first, second and third viewpoints in the source geometry 405. The fourth viewpoint may be more than halfway from the capture viewpoint of the destination scene to the capture viewpoint of the source scene.

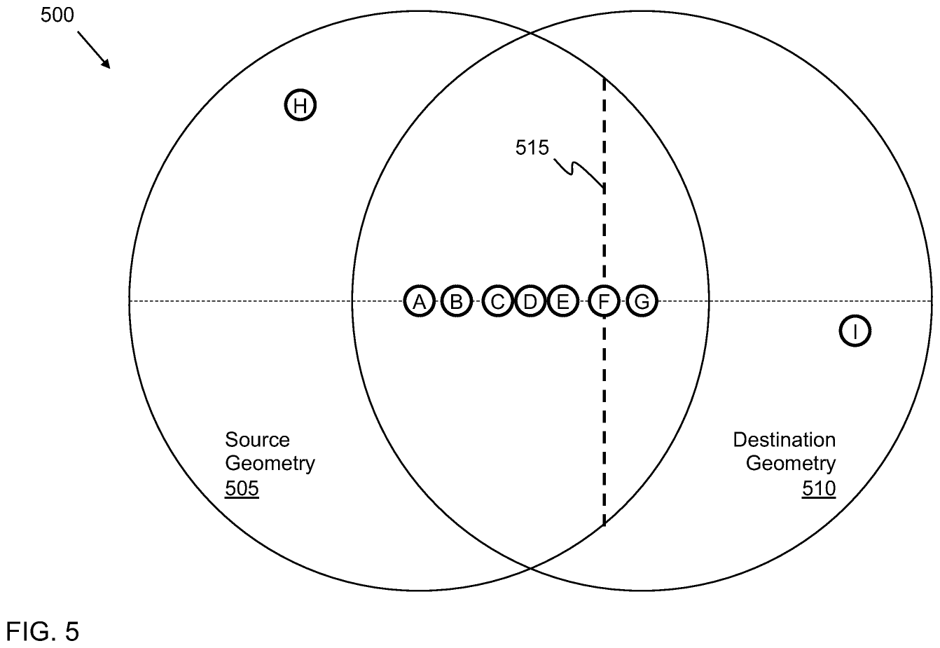

Referring to FIG. 5, there is shown an example of a collection 500 of node geometries. The node geometries include a source geometry 505 and a destination geometry 510. In this example, the source and destination geometries 505, 510 overlap with each other. A set of viewpoints labelled ‘A’ to ‘I’ are depicted. In this example, the user moves from viewpoint ‘A’ to viewpoint ‘G’ via viewpoints ‘B’, ‘C’, ‘D’, ‘E’, and ‘F’. In this example, the viewpoints ‘A’ through ‘G’ are in both the source and destination geometries 505, 510, viewpoint ‘H’ is in the source geometry 505 only, and viewpoint ‘I’ is in the destination geometry 510 only.

Examples described herein provide transitions between different scenes. Transitions may be temporal transitions. A temporal transition, when triggered, has a predetermined duration and is or may be independent of movement of the user after the transition is triggered. Transitions may be spatial transitions. A spatial transition, when triggered, is dependent on movement of the user after the transition is triggered. Blending, and morphing (described below), may be used for temporal transitions and may also be used for spatial transitions.

Returning to FIG. 5, this example uses morphing for the transition. To achieve an even more realistic transition, image morphing algorithms may be applied between the two nodes and associated scenes. The morphing clips can be pre-computed for every pair of neighbouring nodes, based on the optical flow between the respective 360° scenes. Optical flow algorithms are more reliable the more similar the two scenes are. 6DOF may be used to get more accurate optical flow results. In examples, both scenes are transformed to what they would look like at the midpoint between the nodes using 6DOF. They will already be much more similar because 6DOF simulates exactly that motion. The optical flow can be computed based on these transformed scenes. If 6DOF were not used, the two scenes would be represented from their respective camera viewpoints and would therefore be more dissimilar than if 6DOF were used at their midpoints.

It is only possible to morph a representation of the source scene directly into a representation of the destination scene if morphing occurs in real-time. If the morphing clip needs to be precomputed, then morphing takes place based on a fixed representation, since morphing clips cannot be precomputed for every possible representation of both scenes. A transition can, however, still be obtained that starts at the representation of the source scene and ends at the representation of the destination scene, because 6DOF distortion can be applied to the morphing clip itself. Using the midway point to compute the distortion provides a good compromise that is likely to be close to where the actual transition happens, and improves the optical flow results by using more similar scenes owing to the 6DOF distortion.

In this example, only a single, changing, 360° scene is being rendered at a time. This differs from the alpha blending example in which both the source and origin scenes would be rendered (with 6DOF distortion) at the same time as each other in the transition region 415 and alpha blended together. In the morphing example, the two 6DOF configurations of the source and destination scenes can be interpolated between as the morphing transition takes place.

To manage the amount of data used for video-based tours, in some examples morphing clips are not pre-computed for every single video frame. Instead, examples pre-compute these clips only for keyframes. For example, these keyframes may occur every second or two. Then, if a transition is triggered, the transition system waits for the next available morphing clip before beginning the transition. This delay, of the order of a second, is not apparent to the user. In particular, the user is not aware that there has been a delay since they do not have a point of reference for when the transition should happen. A delay of a second is small enough that the user cannot move very far past the point where a transition feels natural.

Transitions, whether alpha blended or morphed, may be triggered in various ways. For temporal transitions, to reduce or avoid flickering between nodes, Nᵢ and Nⱼ, when the user stands exactly between the two nodes, Nᵢ and Nⱼ, a transition is only triggered if the user is closer to the destination node, Nⱼ, than the source node, Nᵢ, by a factor μ. That is, if the user is currently viewing node Nᵢ and the user's position is x, a transition to any node Nⱼ is triggered as soon as:

$$\frac{\vert {r}_{j} - x \vert}{\vert {r}_{i} - x \vert} < μ .$$

The value of p can be adjusted for each tour. It has been found that a value of μ=4/9 works well as a default value.

In this example, the viewpoints ‘A’ to ‘G’ are in source geometry 505 and are also in the destination geometry 510 and correspond, in positions, to the viewpoints ‘A’ to ‘G’ described above with reference to FIG. 4.

In this example, at viewpoint ‘A’, the representation of the source scene at viewpoint ‘A’ is not subject to 6DOF distortion and the user does not see a contribution from the destination scene.

At viewpoints ‘B’, ‘C’, ‘D’ and ‘E’, the user sees respective 6DOF-distorted representations of the source scene and does not see a contribution from the destination scene, even though the viewpoints ‘B’, ‘C’, ‘D’ and ‘E’ are all in the destination geometry 410.

At viewpoint ‘F’, the morphing transition is triggered and the user sees contributions from both the source scene and the destination scene during the morphing transition. Since the transition does not happen instantly, the user will not be exactly at viewpoint ‘F’ at the end of the transition, but will be at a nearby location ‘F_{nearby}’. The transition will therefore go from a 6DOF-distorted representation of the source scene at ‘F’ to a 6DOF-distorted representation of the destination scene at ‘F_{nearby}’.

In this example, viewpoint ‘G’ corresponds to the capture viewpoint of the destination scene. In this example, the representation of the destination scene at viewpoint ‘G’ is not subject to 6DOF distortion. At viewpoint ‘G’, the user does not see a contribution from the source scene, even though viewpoint ‘G’ is still in the source geometry 405.

At viewpoint ‘H’, which is in the source geometry 405 but not the destination geometry 410, the user sees a 6DOF-distorted representation of the source scene and does not see a contribution from the destination scene.

At viewpoint ‘I’, which is in the destination geometry 410 but not the source geometry 405, the user sees a 6DOF-distorted representation of the destination scene and does not see a contribution from the source scene.

The broken line 515 in FIG. 5 may be considered to be a transition trigger.

In this example, a first representation of the source scene is rendered. The first representation of the source scene represents the source scene at a first viewpoint in the source geometry 505. The first viewpoint may, amongst others, be viewpoint ‘A’ or ‘H’.

A second, different representation of the source scene is rendered. The second representation of the source scene represents the source scene at a second, different viewpoint in the source geometry 405. The second viewpoint may, amongst others, be viewpoint ‘B’, ‘C’, ‘D’, or ‘E’.

In this example, the second representation of the source scene is distorted with respect to the first representation of the source scene. In this example, the distortion of the second representation of the source scene with respect to the first representation of the source scene is dependent on positions of the first and second viewpoints in the source geometry 505. For example, a second representation of the source scene at viewpoint ‘B’, ‘C’, ‘D’, or ‘E’ is distorted with respect to a first representation of the source scene at viewpoint ‘A’ or ‘H’. The distortion may be 6DOF distortion.

A transition from the source scene to the destination scene is rendered. The transition from the source scene to the destination scene comprises (i) a third, different representation of the source scene and (ii) a first representation of the destination scene. In this example, the third representation of the source scene represents the source scene at a third, different viewpoint in the source geometry 505.

In this example, the third viewpoint is viewpoint ‘F’. In this example, the third viewpoint is additionally in the destination geometry 510. For example, viewpoint ‘F’ is in the destination geometry 510 in addition to being in the source geometry 505.

In this example, the first representation of the destination scene represents the destination scene at the third viewpoint. For example, the first representation of the destination scene may represent the destination scene at viewpoint ‘F’. In this example, the third representation of the source scene is distorted with respect to the first and second representations of the source scene. In this example, the distortion of the third representation of the source scene with respect to the first and second representations of the source scene is dependent on positions of the first, second and third viewpoints in the source geometry 505. The distortion may be 6DOF distortion.

In this example, the third viewpoint is more than halfway from a capture viewpoint of the source scene to a capture viewpoint of the destination scene.

In this example, a second, different representation of the destination scene is rendered. The second representation of the destination scene represents the destination scene at a second, different viewpoint in the destination geometry 510. The second viewpoint in the destination geometry 510 may, amongst others, be viewpoint ‘G’ or ‘I’.

In this example, the first representation of the destination scene is distorted with respect to the second representation of the destination scene. In this example, the distortion of the first representation of the destination scene with respect to the second representation of the destination scene is dependent on the positions of the first and second viewpoints in the destination geometry 410. For example, where the first and second viewpoints in the destination geometry 510 are viewpoints ‘F’ and ‘I’ respectively, both the first and second representations of the destination scenes are distorted with respect to each other and with respect to a representation of the destination scene at viewpoint ‘G’ (the capture viewpoint of the destination scene). Where the first and second viewpoints in the destination geometry 510 are viewpoints ‘F’ and ‘G’ respectively, both the first and second representations of the destination scenes are distorted with respect to each other, even though the representation of the destination scene at viewpoint ‘G’ (the capture viewpoint of the destination scene) may not itself be a distorted representation of the destination scene. The distortion may be 6DOF distortion.

In this example, the transition comprises morphing the source scene into the destination scene. In this example, the morphing comprises morphing the third representation of the source scene into the first representation of the destination scene.

In this example, the morphing is pre-computed. Where the source and destination scenes comprise video data, which comprises a sequence of images, the pre-computing may be performed on a subset of the images in the sequence of images.

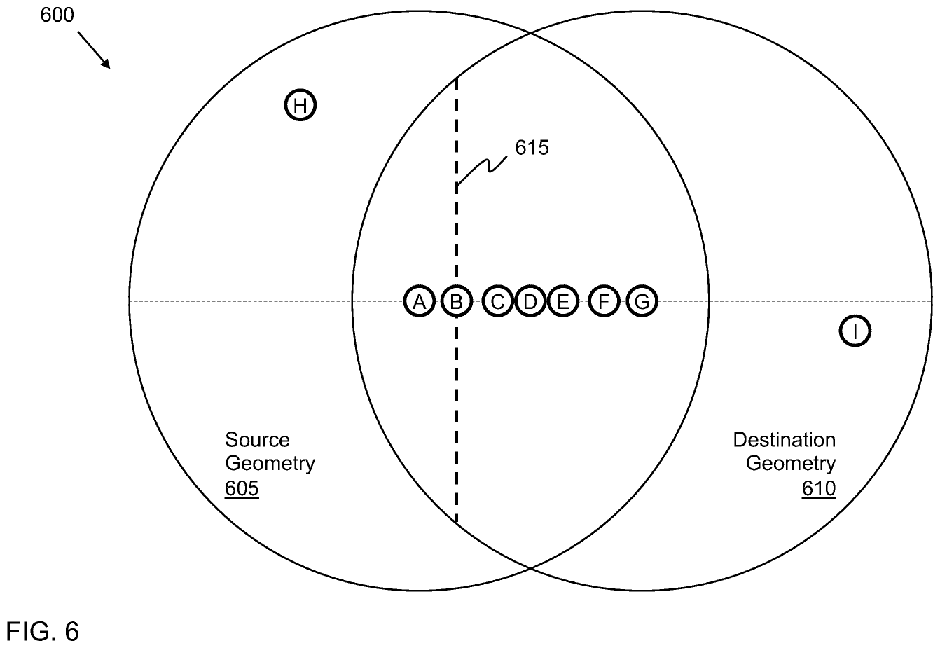

Referring to FIG. 6, the example collection 600 of node geometries corresponds to the collection 500 of node geometries described above with reference to FIG. 5.

In this example, however, the user moves back to viewpoint ‘A’ in the source geometry 605 from viewpoint ‘G’ in the destination geometry 610 via viewpoints ‘F’, ‘E’, ‘D’, ‘C’ and ‘B’.

The user sees representations of the destination scene at each of viewpoints ‘G’, ‘F’, ‘E’, ‘D’ and ‘C’ in moving from viewpoint ‘G’ to viewpoint ‘A’.

In particular, whereas the morphing transition was triggered at viewpoint ‘F’ in moving from viewpoint ‘A’ to viewpoint ‘G’, in moving from viewpoint ‘G’ to viewpoint ‘A’, the morphing transition is not triggered at viewpoint ‘F’. Instead, at viewpoint ‘F’, the user sees a 6DOF-distorted representation of the destination scene and does not see a contribution from the source scene. The morphing transition from the destination scene to the source scene is, instead, triggered at viewpoint ‘B’ as the user moves from viewpoint ‘G’ to viewpoint ‘A’.

The broken line 615 in FIG. 6 may be considered to be a transition trigger.

In this example, a transition from the destination scene 610 to the source scene 605 is rendered. The transition is based on a fourth, different representation of the source scene. The fourth representation of the source scene is different from the first, second and third representations of the source scene described above with reference to FIG. 5. The fourth representation of the source scene represents the source scene at a fourth, different viewpoint in the source geometry. The fourth viewpoint in the source geometry 605 is different from the first, second and third viewpoints in the source geometry 605 described above with reference to FIG. 5. In this example, the fourth viewpoint is more than halfway from the capture viewpoint of the destination scene to the capture viewpoint of the source scene. The fourth viewpoint may, for example, be viewpoint ‘B’.

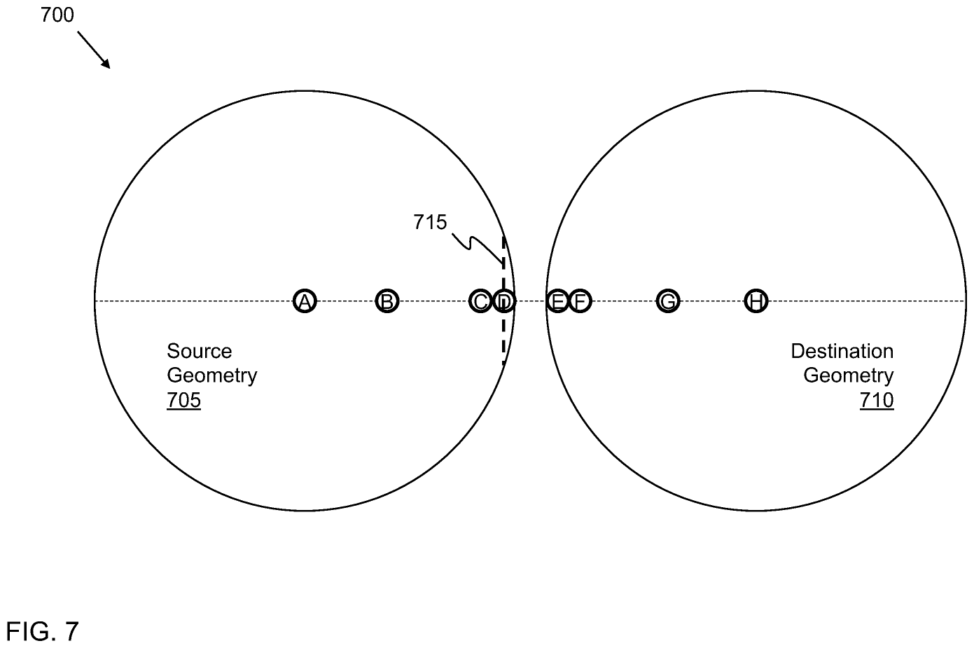

Referring to FIG. 7, there is shown an example of a collection 700 of node geometries. The node geometries include a source geometry 705 and a destination geometry 710. In this example, the source and destination geometries 705, 710 do not overlap with each other. A set of viewpoints labelled ‘A’ to ‘I’ are depicted. In this example, the user moves from viewpoint ‘A’ in the source geometry 705 to viewpoint ‘G’ in the destination geometry 710 via viewpoints ‘B’, ‘C’, ‘D’, ‘E’, and ‘F’. Transitions between the source and destination scenes may still be rendered where the source and destination geometries 705, 710 do not overlap with each other. Such transitions may comprise morphing as described above. For example, the broken line 715 in FIG. 7 may be considered to be a transition trigger. When the user reaches the transition trigger 715, a morphing from a representation of the source scene at viewpoint ‘D’ in the source geometry 705 into a first representation of the destination scene at viewpoint ‘E’ in the destination geometry 710 may be rendered. The morphing may have been pre-computed.

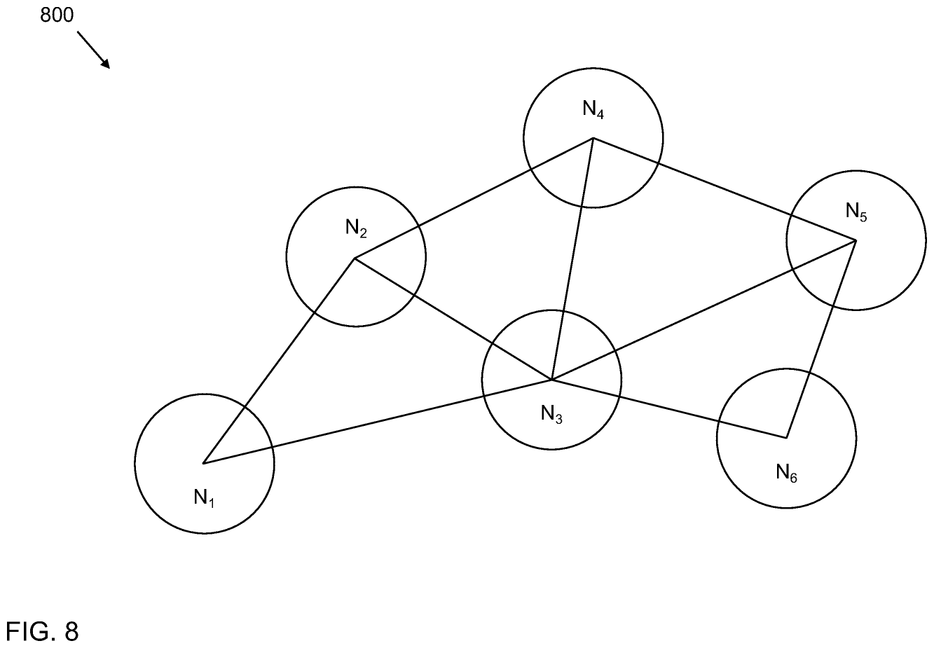

Referring to FIG. 8, there is shown an example graph 800 of a collection of nodes. In this example, the graph 800 represents an immersive experience. In addition to first and second nodes, the graph 800 comprises a further node comprising a further scene. In this specific example, the graph 800 comprises multiple such further nodes.

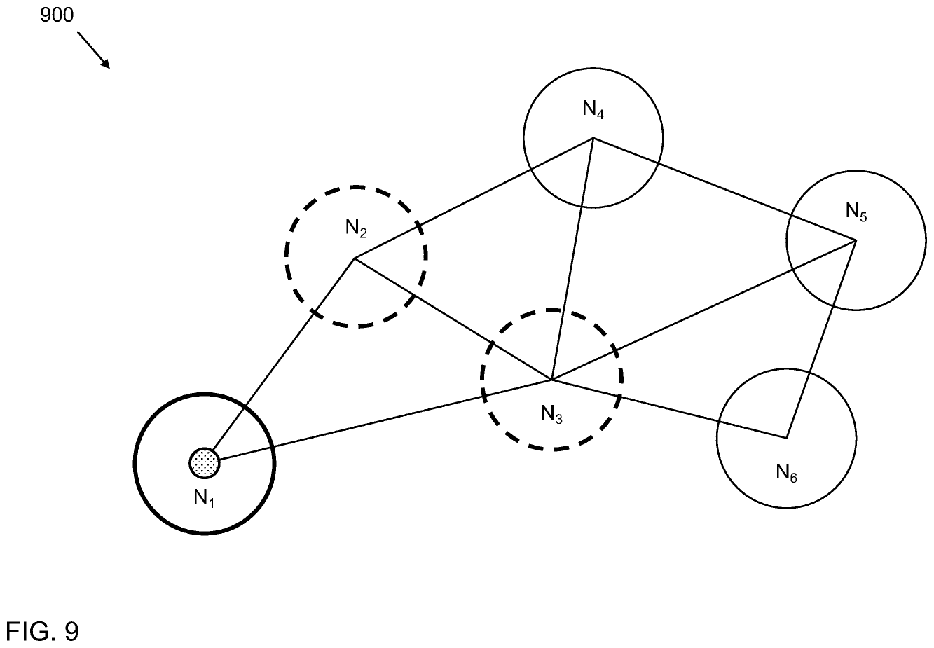

Referring to FIG. 9, there is shown an example graph 900 of a collection of nodes. In this example, the viewpoint is currently in the geometry of the first node, N₁. Texture map data of the first node, N₁, is loaded into the texture memory 220. The second and third nodes, N₂ and N₃, are neighbouring nodes of the first node, N₁, in the graph 900. Texture map data of the second and third nodes, N₂ and N₃, is also loaded into the texture memory 220. The first, second and third scenes might not all be rendered while the viewpoint is in the geometry of the first node, N₁. However, the texture map data is nevertheless proactively loaded into the texture memory 220 to be available for use.

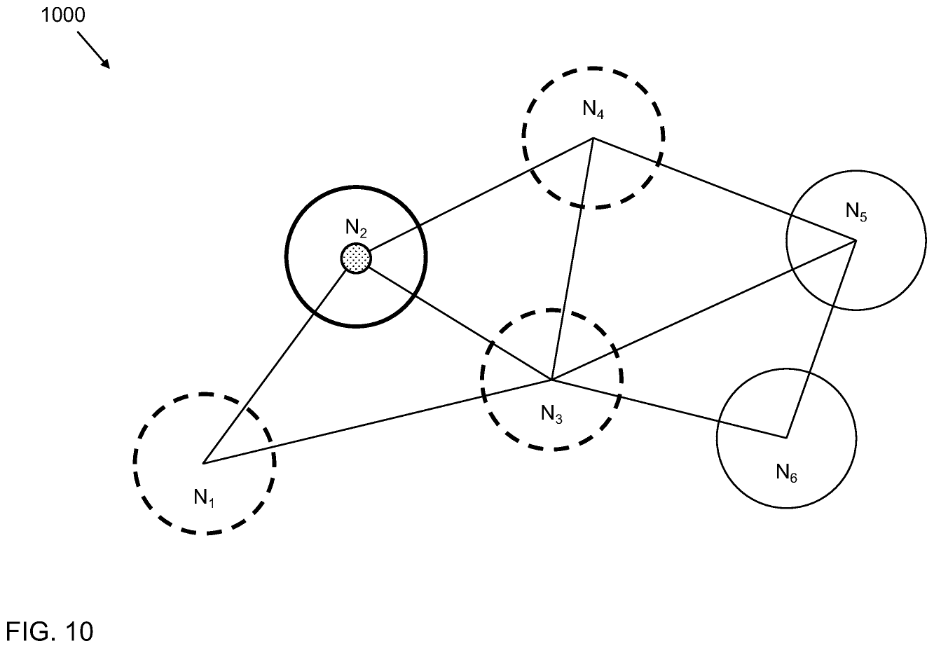

Referring to FIG. 10, there is shown an example graph 1000 of a collection of nodes. In this example, the viewpoint has moved from the geometry of the first node, N₁, into the geometry of the second node, N₂. Texture map data of the first, second and third nodes, N₁, N₂ and N₃, is maintained in the texture memory 220 since the viewpoint is in the geometry of the second node, N₂, and since the first and third nodes, N₁ and N₃, are neighbouring nodes of the second node, N₂. The fourth node, N₄, is also a neighbour node of the second node, N₂, and its texture map data is loaded into the texture memory 220.

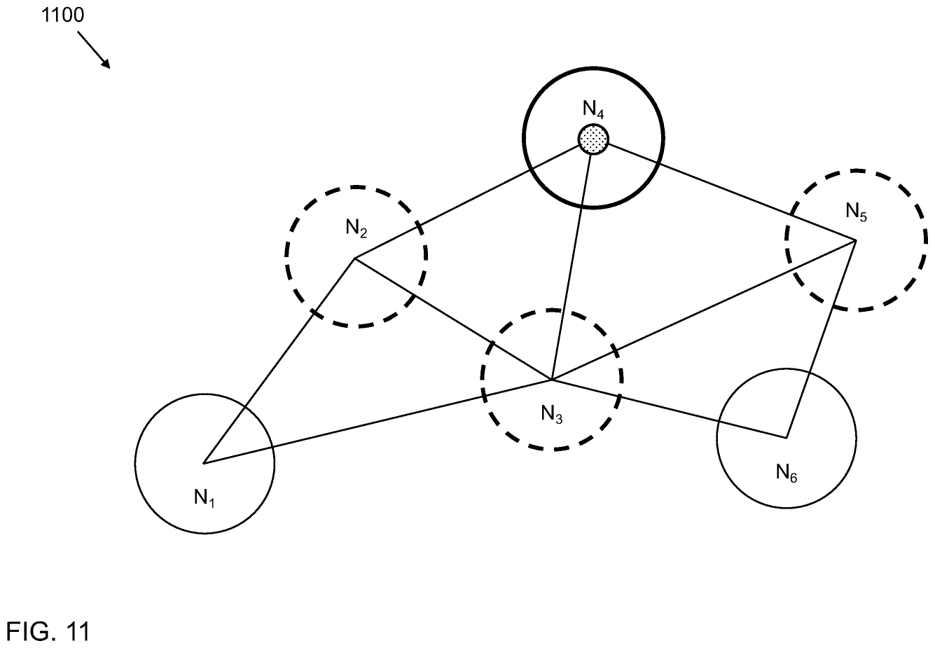

Referring to FIG. 11, there is shown an example graph 1100 of a collection of nodes. In this example, the viewpoint has moved from the geometry of the second node, N₂, into the geometry of the fourth node, N₄. Texture map data of the second, third and fourth nodes, N₂, N₃ and N₄, is maintained in the texture memory 220 since the viewpoint is in the geometry of the fourth node, N₄, and since the second and third nodes, N₂ and N₃, are neighbouring nodes of the fourth node, N₄. The fifth node, N₅, is also a neighbour node of the fourth node, N₄, and its texture map data is loaded into the texture memory 220. However, the first node, N₁, is not a neighbour node of the fourth node, N₄, and its texture map data is removed from the texture memory 220.

In this example, taking the second and fourth nodes, N₂ and N₄, as source and destination nodes respectively, a further node (namely, the first node, N₁) is a neighbour node of the source node (the second node, N₂) and is not a neighbour node of the destination node (the fourth node, N₄). In response to the rendering of a transition from the source scene (of the second node, N₂) to the destination scene (of the fourth node, N₄) completing, texture map data for the further node (the first node, N₁) is caused to be removed from the texture memory 220 of the GPU 225. The texture map data for the further node (the first node, N₁) may be caused to be removed from the texture memory 220 of the GPU 225 in response to a different trigger relating to the transition (different from the rendering of the transition completing) in other examples. Another example of a trigger related to a transition is the transition commencing.

Alternatively, in this example, taking the second and fourth nodes, N₂ and N₄, as source and destination nodes respectively, a further node (namely, the third node, N₃) is a neighbour node of the source node (the second node, N₂) and is a neighbour node of the destination node (the fourth node, N₄). Texture map data for the further node (the third node, N₃) is caused to be maintained in the texture memory 220 of the GPU 225 following completion of the rendering of a transition from the source scene (of the second node, N₂) to the destination scene (of the fourth node, N₄).

Alternatively, in this example, taking the second and fourth nodes, N₂ and N₄, as source and destination nodes respectively, a further node (namely, the fifth node, N₅) is not a neighbour node of the source node (the second node, N₂) but is a neighbour node of the destination node (the fourth node, N₄). In response to the rendering of a transition from the source scene (of the second node, N₂) to the destination scene of the fourth node, N₄) completing, texture map data for the further node (the fifth node, N₅) is caused to be loaded into the texture memory 220 of the GPU 225.

In this example, the rendering of the first representation of a source scene (for example of the first node N₁), the rendering of the second representation of the source scene (for example of the first node N₁), and the generating of the rendering of the transition from the source scene to the destination scene (for example of the second node N₂) are not dependent upon a representation of a further scene (for example of the third, fourth, fifth or sixth nodes N₃, N₄, N₅, N₆) having been rendered.

With reference to FIGS. 9 to 11, since the sixth node, N₆, is not a neighbour node of any of the first, second or fourth nodes, N₁, N₂ and N₄, its texture map data has not been loaded into the texture memory 220 of the GPU 225. The sixth scene may not be rendered at all as the user experiences the tour, if the user does not move into the geometry of the sixth node, N₆.

In terms of transitions between tour nodes in accordance with the present disclosure, the user can freely move within the geometry of a tour node using 6DOF technology. Once the user moves sufficiently close to another node, a transition is triggered to the new node. The transition can happen independently of the user's position. Owing to the use of 6DOF technology, the images that are being transitioned between are much more similar. Consequently, the transition can be much shorter, creating a more natural and less jarring experience.

Compared to existing systems, the user can view scenes from multiple viewpoints in a given node geometry, including in VR. In examples, transitions between scenes are more natural, compared to applying a generic distortion and blending.

Some existing systems provide somewhat realistic transitions in a browser where 360° images are rendered onto a fully recovered 3D model of the tour's environment. However, when the model does not match the environment accurately, very distracting visual artefacts can arise. When viewed in VR, in such systems, the user is still limited to a 3DOF experience and transitions are simply teleports to a new node. The user cannot explore the scene by physically walking.

Other existing systems, again, only allow the user to view the scene from the exact camera positions used to capture the scenes. In a browser, transitions between scenes apply generic motion blur and blending. In VR, some transitions apply a 6DOF-like effect inside a cuboid geometry while blending. However, neither the geometry nor the placement and orientation of nodes accurately reflects the physical space, which makes the transitions disorienting and unnatural.

Other existing systems create 3D geometries from planar 2D images for realistic transitions and involve some distortion of the images to enhance the realism of the transition. Examples described herein use, or at least are compatible with, spherical, rather than planar images, and allow the user to move around the tour freely, instead of being restricted to specific viewpoints and transitions.

Other existing systems enable tours to be navigated based on recreated depth maps and 3D geometry, potentially using a “tunnel” of planar images. Examples described herein work with spherical, instead of planar, images and allow arbitrary movement within the entirety of the tour space. Examples described herein also do not require the complete scene geometry to be reconstructed.

The reader is referred to WO-A1-2020/084312, filed by the present applicant, which relates to providing at least a portion of content having 6DOF motion and the entire contents of which are hereby incorporated herein by reference. As explained above, 6DOF motion allows the user to move about to explore a space freely. The reader is also referred to a UK patent application filed by the present applicant on the same date as the present application, entitled “Configuring An Immersive Experience” and relating to automatically setting up an immersive experience, the entire contents of which are also hereby incorporated herein by reference. With a system providing 6DOF motion and natural transitions between scenes, accurate positioning and rotation of each scene significantly enhances the immersive experience. As such, the present disclosure has a strong synergy with, and enhances, the natural locomotion throughout a virtual tour enabled by providing 6DOF motion and accurate configuration of the tour.

Various measures have been described above in relation to rendering an immersive experience. Such measures include methods, apparatuses configured to perform such methods and computer programs comprising instructions which, when the program is executed by a computer, cause the computer to perform such methods.

In the context of this specification “comprising” is to be interpreted as “including”.

Aspects of the invention comprising certain elements are also intended to extend to alternative embodiments “consisting” or “consisting essentially” of the relevant elements.

Where technically appropriate, embodiments of the invention may be combined.

Embodiments are described herein as comprising certain features/elements. The disclosure also extends to separate embodiments consisting or consisting essentially of said features/elements.

Technical references such as patents and applications are incorporated herein by reference.

Any embodiments specifically and explicitly recited herein may form the basis of a disclaimer either alone or in combination with one or more further embodiments.

1. A method of rendering an immersive experience, the immersive experience comprising a source node and a destination node, the source node comprising a source scene and a source geometry, the destination node comprising a destination scene and a destination geometry, the method comprising:
rendering a first representation of the source scene, the first representation of the source scene representing the source scene at a first viewpoint in the source geometry;
rendering a second, different representation of the source scene, the second representation of the source scene representing the source scene at a second, different viewpoint in the source geometry; and
rendering a transition from the source scene to the destination scene, the transition comprising:
a third, different representation of the source scene, the third representation of the source scene representing the source scene at a third, different viewpoint in the source geometry; and
a first representation of the destination scene.

2. The method according to claim 1, wherein the source and destination geometry overlap with each other, optionally wherein the third viewpoint is additionally in the destination geometry.

3. (canceled)

4. The method according to claim 2, wherein the first representation of the destination scene represents the destination scene at the third viewpoint.

5. The method according to claim 1, wherein the second representation of the source scene is distorted with respect to the first representation of the source scene, and wherein the distortion of the second representation of the source scene with respect to the first representation of the source scene is dependent on positions of the first and second viewpoints in the source geometry.

6. The method according to claim 1, wherein the third representation of the source scene is distorted with respect to the first and second representations of the source scene, and wherein the distortion of the third representation of the source scene with respect to the first and second representation of the source scene is dependent on positions of the first, second and third viewpoints in the source geometry.

7. The method according to claim 1, comprising
rendering a second, different representation of the destination scene, the second representation of the destination scene representing the destination scene at a second, different viewpoint in the destination geometry,
optionally wherein the first representation of the destination scene is distorted with respect to the second representation of the destination scene, and wherein the distortion of the first representation of the destination scene with respect to the second representation of the destination scene is dependent on positions of the first and second viewpoints in the destination geometry.

8. (canceled)

9. The method according to claim 1, wherein the transition comprises alpha-blending the third representation of the source scene with the first representation of the destination scene;
optionally wherein the transition comprises alpha-blending at least one further representation of the source scene with at least one further representation of the destination scene, wherein a first value of a blending parameter is used to alpha-blend the third representation of the source scene with the first representation of the destination scene, and wherein at least one further, different value of the blending parameter is used to alpha-blend the at least one further representation of the source scene with the at least one further representation of the destination scene.

10. (canceled)

11. The method according to claim 1, wherein the transition comprises morphing the source scene into the destination scene.

12. The method according to claim 11, wherein the morphing comprises morphing the third representation of the source scene into the first representation of the destination scene.

13. The method according to claim 11, comprising pre-computing the morphing, optionally wherein the source and destination scenes comprise video data, wherein the video data comprises a sequence of images, and wherein the pre-computing is performed on a subset of the images in the sequence of images.

14. (canceled)

15. The method according to claim 1, wherein the third viewpoint is more than halfway from a capture viewpoint of the source scene to a capture viewpoint of the destination scene;
optionally further comprising:
rendering a transition from the destination scene to the source scene, the transition being based on a fourth, different representation of the source scene, the fourth representation of the source scene representing the source scene at a fourth, different viewpoint in the source geometry,
wherein the fourth viewpoint is more than halfway from the capture viewpoint of the destination scene to the capture viewpoint of the source scene.

16. (canceled)

17. The method according to claim 1, wherein the immersive experience comprises a further node comprising a further scene.

18. The method according to claim 17, wherein the rendering of the first representation of the source scene, the rendering of the second representation of the source scene, and the generating of the rendering of the transition from the source scene to the destination scene are not dependent upon a representation of the further scene having been rendered.

19. The method according to claim 17, wherein the further node is a neighbour node of the source node in the immersive experience, wherein the further node is not a neighbour node of the destination node in the immersive experience, and wherein the method comprises:
in response to a trigger related to the transition from the source scene to the destination scene, causing texture map data for the further node to be removed from texture memory of a graphics processing unit, GPU.

20. The method according to claim 17, wherein the further node is a neighbour node of the source node in the immersive experience, wherein the further node is a neighbour node of the destination node in the immersive experience, and wherein the method comprises:
causing texture map data for the further node to be maintained in texture memory of a graphics processing unit, GPU, following a trigger related to the transition from the source scene to the destination scene.

21. The method according to claim 17, wherein the further node is not a neighbour node of the source node in the immersive experience, wherein the further node is a neighbour node of the destination node in the immersive experience, and wherein the method comprises:
in response to a trigger related to the transition from the source scene to the destination scene, causing texture map data for the further node to be loaded into texture memory of a graphics processing unit, GPU.

22. The method according to claim 1, comprising causing the first representation of the source scene, the second representation of the source scene and the transition from the source scene to the destination scene to be displayed on a display of a virtual reality, VR, headset.

23. The method according to claim 1, wherein the transition from the source scene to the destination scene is rendered in response to movement of a viewer of the immersive experience in a physical space.

24. An apparatus configured to perform a method of rendering an immersive experience, the immersive experience comprising a source node and a destination node, the source node comprising a source scene and a source geometry, the destination node comprising a destination scene and a destination geometry, the method comprising:
rendering a first representation of the source scene, the first representation of the source scene representing the source scene at a first viewpoint in the source geometry;
rendering a second, different representation of the source scene, the second representation of the source scene representing the source scene at a second, different viewpoint in the source geometry; and
rendering a transition from the source scene to the destination scene, the transition comprising:
a third, different representation of the source scene, the third representation of the source scene representing the source scene at a third, different viewpoint in the source geometry; and
a first representation of the destination scene.

25. A computer program comprising instructions which, when the program is executed by a computer, cause the computer to perform a method of rendering an immersive experience, the immersive experience comprising a source node and a destination node, the source node comprising a source scene and a source geometry, the destination node comprising a destination scene and a destination geometry, the method comprising:
rendering a first representation of the source scene, the first representation of the source scene representing the source scene at a first viewpoint in the source geometry;
rendering a second, different representation of the source scene, the second representation of the source scene representing the source scene at a second, different viewpoint in the source geometry; and
rendering a transition from the source scene to the destination scene, the transition comprising:
a third, different representation of the source scene, the third representation of the source scene representing the source scene at a third, different viewpoint in the source geometry; and
a first representation of the destination scene.
